(19) United States
(12) Patent Application Publication
(10) Pub. No.: US 2009/0199597 A1
(43) Pub. Date: Aug. 13, 2009

(54) Systems and methods for collapsing air lines in nanostructured optical fibers

(76) Inventors: Jeffrey D. Danley, Hickory, NC (US); Dennis M. Knecht, Hickory, NC (US); Robert S. Wagner, Corning, NY (US)

Correspondence Address: CORNING INCORPORATED, INTELLECTUAL PROPERTY DEPARTMENT, SP-TI-3-1, CORNING, NY, 14831, US

(21) Appl. No.: 12/069,123

(22) Filed: Feb. 7, 2008

(51) Int. Cl. C03C 25/62; B23K 26/00

(52) U.S. Cl. 65/392; 219/121.65

(57) ABSTRACT

Systems and methods of collapsing the air lines in the air line-containing region of a nanostructure optical fiber are disclosed. One method includes initiating irradiation of a portion of the nanostructure optical fiber from essentially opposite directions with at least first and second laser beams having substantially equal power and essentially the same mid-infrared wavelength. The method includes continuing the irradiation for an irradiation time t₁ so as to bring the optical fiber portion to a softening temperature T_{S} at which the air lines in the optical fiber portion collapse into the adjacent cladding. Exemplary optical systems for carrying out the air- line-collapsing methods of the present invention are also disclosed.

### BACKGROUND OF THE INVENTION

1. Field of the Invention

The present invention relates generally to nanostructured optical fibers, and in particular relates to systems for and methods of collapsing the air lines in the nanostructured region of a nanostructured optical fiber at a select location.

2. Technical Background of the Invention

Fiber optical systems are used for an increasing variety of telecommunication-related applications ranging from high-data-rate transmission to radio-over-fiber (ROF) to wireless system networks. With the increasing number of applications, the fiber optic cables used in such systems are being deployed in a greater variety of structures and infrastructures. Improper handling and deployment of a fiber optic cable can result in macrobending losses, also known as “extrinsic losses.” In ray-optics terms, severe bending of an optical fiber can cause the angles at which the light rays reflect within the fiber to exceed the critical angle of reflection. Stated in electromagnetic-wave terms, the bending causes one or more of the guided modes of the optical fiber to become “leaky modes” wherein light escapes or “leaks” from the guiding region of the fiber. Such bending losses can be prevented by observing the minimum bend radius of the particular optical fibers and optical fiber cables that carry the optical fibers.

Consequently, the optical fibers carried in the fiber optic cables need to be increasingly more “bend resistant” so that the fibers can be deployed with tighter bends without the optical signals carried therein experiencing significant attenuation. This has lead to the development of advanced types of optical fibers that have enhanced bend performance. Enhanced bend performance allows for fiber optic cables to be deployed in a greater number of locations that might not otherwise be suitable due to the tight bending limits presented by the locations.

One type of bend-performance optical fiber is a “nanostructure” or “holey” fiber that utilizes small holes or voids formed in the optical fiber. While nanostructure fibers offer a significant increased improvement in the minimum bend radius, there are issues with connectorizing such fibers due to the voids present at the end of a cleaved fiber. One connectorization issue is that contaminants can fill the fiber voids and ingress at the fiber end, which reduces the efficiency of the connection. Such contaminants include moisture and micro-debris generated at the connector end face during the connector polishing processes, such as mixtures of zirconium ferrule material and silica glass removed during polishing, abrasives from polishing films, and deionized water. These contaminants may become trapped or embedded in the fiber at the connector end face. Due to the various forces and the attendant heat the connector end experiences during the polishing process, contamination in the fiber end is extremely difficult to remove. In addition, contamination in the fiber that is freed during operation and/or handling of the fiber optic system and that moves across the connector end face into the fiber core region may also increase signal attenuation.

While cleaning the fibers after the connector polishing step may be possible using methods such as ultrasonic cleaning, this is most often only a temporary fix. After exposure to dust, moisture and other contaminants such as discussed above, as well as exposure to traditional cleaning materials like lint-free wipes and micro-fiber cloths, the fibers still remain at risk of future contamination while the fiber ends include open voids. While the fiber ends may be treated using UV or heat cured materials such as epoxies that fill the fiber voids, the adhesive used to seal the fiber end may polish at a different rate than that the optical fiber itself, causing indentations or protrusions on the connector end face. These types of vestigial features may potentially interfere with the physical contact of the connector end faces during mating or, in the case of indentations, may serve as areas for debris or other contaminants to collect and adversely impact connector performance.

### SUMMARY OF THE INVENTION

A first aspect of the invention is a method of forming a collapsed air line region in a nanostructure optical fiber having a region with air lines adjacent a cladding region. The method includes initiating irradiation of a portion of the nanostructure optical fiber from opposite directions with at least first and second laser beams having preferably having substantially equal power and essentially the same mid-infrared wavelength. The method further includes continuing said irradiation for an irradiation time t₁ so as to bring the optical fiber portion to a softening temperature T_{S} in the range from about 1585° C. to about 1685° C. at which the air lines in the optical fiber portion collapse into the adjacent cladding without deforming the optical fiber.

A second aspect of the invention is a method of collapsing air lines in a portion of a nanostructure optical fiber that includes an air line region formed within a cladding region. The method includes forming at least first and second laser beams each having a respective, mid-infrared (MIR) wavelength and an optical power that is the same or substantially the same. The method also includes irradiating the optical fiber portion with the at least first and second laser beams from essentially opposite directions so as to uniformly heat the optical fiber portion. The method further includes carrying out said irradiating for an irradiation time t₁ to bring the optical fiber portion to a softening temperature at which the air lines collapse into the cladding region.

As a result of either of the above-described methods, the irradiated optical fiber portion becomes solid by the air lines collapsing into the adjacent cladding region. The optical fiber is then cleaved at the solid portion to create at least one optical fiber end that has no air lines. This solid optical fiber end can then be arranged at the end of a connector ferrule to connectorize the nanostructure optical fiber. The cleaving of the now-solid optical fiber portion can result in either one or two solid optical fiber ends, depending on whether the optical fiber portion was a mid-span portion or an end portion.

A third aspect of the invention is an optical system for collapsing air lines in a portion of a optical fiber that includes an air line region formed within a cladding region, for example, a nanostructure optical fiber. The optical system includes at least one laser source adapted to emit an initial laser beam having a mid-infrared (MIR) wavelength, and a beam-expansion/collimation (B/C) optical system arranged downstream of the laser and adapted to receive the initial laser beam and form therefrom a collimated laser beam. The optical system also includes a beamsplitter arranged downstream of the B/C optical system. The beamsplitter is adapted to form from the initial laser beam at least first and second laser beams having substantially the same optical power. The optical system also includes a mirror system preferably comprising first, second and third mirrors configured to direct the first and second laser beams from the beamsplitter to travel along a common optical axis but in essentially opposite directions. The optical system further includes first and second cylindrical lenses arranged on respective sides of a fiber holder and configured along said common optical axis so as to respectively receive the first and second laser beams and form therefrom respective first and second converging laser beams that converge at the optical fiber portion supported by the fiber holder. This results in the at least two laser beams irradiating opposite sides of the optical fiber portion to effectuate uniform heating of the optical fiber portion so as to collapse the air lines into the cladding region by heating the optical fiber portion to the softening point and no further so that the shape and size of the optical fiber portion remains unchanged.

Additional features and advantages of the invention will be set forth in the detailed description which follows, and in part will be readily apparent to those skilled in the art from that description or recognized by practicing the invention as described herein, including the detailed description which follows, the claims, as well as the appended drawings. It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

FIG. 1 is a side view of a section of nanostructure optical fiber schematically illustrating the air lines (40) formed therein;

FIG. 2 is a cross-sectional view of the nanostructure optical fiber of FIG. 1 as viewed in the direction 2-2 indicated therein, along with an example effective refractive index profile for the various fiber regions, showing the nanostructure region and an inset that shows the air lines (40) present therein;

FIG. 3 is a schematic diagram of an example embodiment of the optical system of the present invention used to carry out the methods of collapsing the air lines in a portion of the nanostructure optical fiber;

FIG. 4A is a close-up side view of an example embodiment of the fiber holder of the optical system of FIG. 3 showing a bare nanostructure fiber being supported thereby;

FIG. 4B is a cross-sectional view of the fiber holder of FIG. 4A as viewed in the direction 4B-4B shown in FIG. 4A;

FIG. 4C is similar to FIG. 4A, and illustrates an example embodiment of a fiber holder that has a gap spanned by the bare nanostructure fiber and that facilitates irradiation of the bare fiber without the potential for interference from the body portion of the fiber holder;

FIG. 5A is a close-up side view of another example embodiment of the fiber holder of the optical system of FIG. 3 showing the nanostructure fiber being held thereby;

FIG. 5B is a cross-sectional view of the fiber holder of FIG. 5A as viewed in the direction 5B-5B shown in FIG. 5A;

FIG. 5C illustrates an example embodiment of a fiber holder that holds the bare fiber vertically;

FIG. 6A is a side view of a nanostructure optical fiber showing a bare fiber portion exposed at a mid-span location by stripping away a corresponding portion of the fiber's protective cover;

FIG. 6B is a side view similar to FIG. 6A, but wherein the bare fiber is cleaved to form a bare-fiber end portion;

FIG. 7A is a close-up side view of the bare fiber section portion being irradiated from both sides by the line-focused light beams from the opposing cylindrical lenses in the optical system of FIG. 3, wherein the V-groove fiber holder of FIG. 4A and FIG. 4B is used;

FIG. 7B is a close-up side view of the bare fiber portion being irradiated from both sides by the focused light beams from the opposing cylindrical lenses in the optical system for the caliber-type fiber holder shown in FIG. 5A and FIG. 5B;

FIG. 7C is similar to FIG. 7B but that only shows one cylindrical lens for the sake of illustration, and that illustrates an example embodiment wherein the cylindrical lens is located at a distance from the fiber central axis (A5) that is shorter than the focal length f of the lenses;

FIG. 8A is a close-up view of a mid-span location of the nanostructure fiber showing the collapsed air line portion of the bare fiber and a cleave plane within the collapsed air line portion;

FIG. 8B is the close up view of FIG. 8A, but wherein the bare fiber has been cleaved at the cleave plane to form two fiber sections each having a solid end as formed by the collapsed air line portion;

FIG. 8C is a close-up view of an end-span portion of the nanostructure fiber similar to that of FIG. 6, but showing the collapsed air line portion of the bare fiber and a cleave plan within the collapsed air line portion;

FIG. 8D is the close-up view of FIG. 8C, wherein the bare fiber has been cleaved at the cleave plane to form a solid end portion as formed by the collapsed air line portion; and

FIG. 9 is a schematic close-up cross-sectional diagram of a connector ferrule that contains a nanostructure fiber having a collapsed air line portion arranged at the ferrule end face in forming a connectorized nanostructure fiber.

### DETAILED DESCRIPTION OF THE PREFERRED EMBODIMENTS

Reference is now made in detail to the present preferred embodiments of the invention, examples of which are illustrated in the accompanying drawings. Whenever possible, the same reference numbers and symbols are used throughout the drawings to refer to the same or like parts.

### Nanostructure Optical Fibers

In the description below, the “refractive index profile” is the relationship between refractive index or relative refractive index and waveguide fiber radius. The “relative refractive index percent” is defined as Δᵢ(%)=[(nᵢ²−n_{c}²)/2nᵢ2]×100, where nᵢ is the maximum refractive index in region i, unless otherwise specified, and n_{c} is the average refractive index of the cladding region. In an example embodiment, n_{c} is taken as the refractive index of the inner annular cladding region 32.

As used herein, the relative refractive index percent is represented by Δ(%) or just “Δ” for short, and its values are given in units of “%”, unless otherwise specified or as is apparent by the context of the discussion.

In cases where the refractive index of a region is less than the average refractive index of the cladding region, the relative refractive index percent is negative and is referred to as having a “depressed region” or a “depressed index,” and is calculated at the point at which the relative refractive index is most negative unless otherwise specified. In cases where the refractive index of a region is greater than the average refractive index of the cladding region, the relative refractive index percent is positive and the region can be said to be raised or to have a positive index.

An “updopant” as the term is used herein is considered to be a dopant that has a propensity to raise the refractive index relative to pure undoped SiO₂. Likewise, a “downdopant” is considered to be a dopant that has a propensity to lower the refractive index relative to pure undoped SiO₂. An updopant may be present in a region of an optical fiber having a negative relative refractive index when accompanied by one or more other dopants that are not updopants. Likewise, one or more other dopants that are not updopants may be present in a region of an optical fiber having a positive relative refractive index. A downdopant may be present in a region of an optical fiber having a positive relative refractive index when accompanied by one or more other dopants that are not downdopants. Likewise, one or more other dopants that are not downdopants may be present in a region of an optical fiber having a negative relative refractive index.

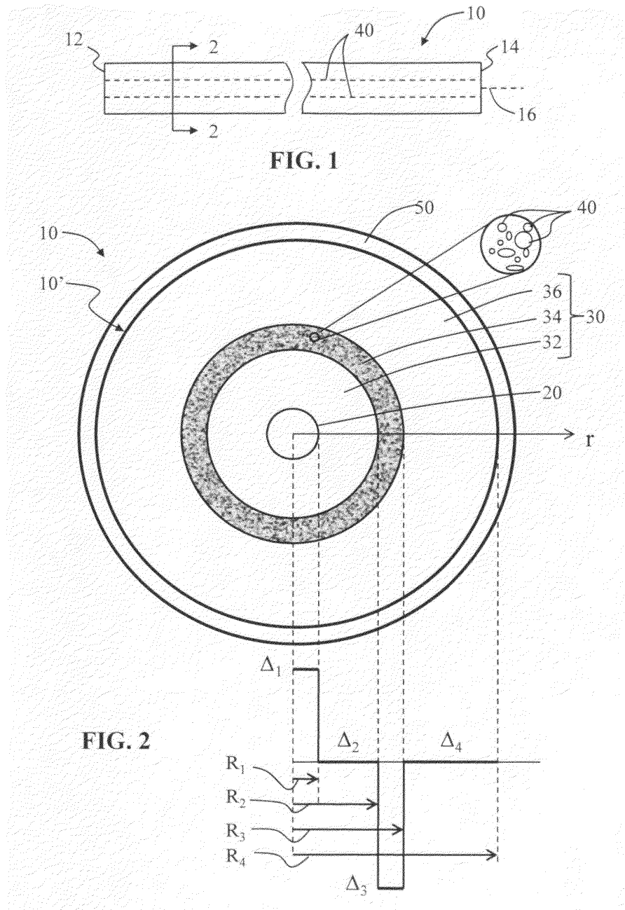

FIG. 1 is a side view of an example embodiment of a section of nanostructure optical fiber (“nanostructure fiber”) 10 having opposite ends 12 and 14, and a centerline 16. FIG. 2 is a cross-sectional view of nanostructured fiber 10 as viewed along the direction 2-2 of FIG. 1. Nanostructure fiber 10 includes a core region (“core”) 20 made up of a single core segment having a radius R₁ and positive maximum relative refractive index Δ₁, a cladding region (“cladding”) 30 having an annular inner cladding region (“inner cladding”) 32 with an inner radius R₁, an outer radius R₂ an annular width W₁₂ and a relative refractive index Δ₂, an annular nanostructured or “air line-containing region” 34 having an inner radius R₂, an outer radius R₃ an annular width W₂₃ and a relative refractive index A₃, and an outer annular cladding region (“outer cladding”) 36 having an inner radius R₃, an outer radius R₄, an annular width W₃₄ and a relative refractive index Δ₄. Outer annular cladding 36 represents the outermost silica-based portion of nanostructure fiber 10. A protective cover 50 is shown surrounding outer annular cladding 36. In an example embodiment, protective cover 50 includes one or more polymer or plastic-based layers or coatings, such as a buffer coating or buffer layer. Nanostructure fiber 10 without protective cover 50 (e.g., when the protective cover is stripped way) is referred to herein as “bare fiber 10′.”

Annular hole-containing region 34 is comprised of periodically or non-periodically disposed holes 40—referred to hereinafter as “air lines”—that run substantially parallel to centerline 16. FIG. 1 schematically depicts air lines 40 in air line-containing region 34 as dashed lines for the sake of illustration. In an example embodiment, air lines 40 are configured such that the optical fiber is capable of single-mode transmission at one or more wavelengths in one or more operating wavelength ranges. By “non-periodically disposed” or “non-periodic distribution,” it will be understood to mean that a cross-section (such as a cross-section perpendicular to the longitudinal axis) of the optical fiber, shows the non-periodically disposed air lines to be randomly or non-periodically distributed across a portion of the fiber. Similar cross sections taken at different points along the length of the fiber will reveal different cross-sectional hole patterns, i.e., various cross-sections will have different air line patterns, wherein the distributions of the air lines and sizes of the air lines do not match. That is, the air lines are non-periodic, i.e., they are not periodically disposed within the fiber structure. These air lines are stretched (elongated) along the length (i.e., in a direction generally parallel to the longitudinal axis) of the optical fiber, but do not extend the entire length of the entire fiber for typical lengths of transmission fiber.

Nanostructure optical fibers 10 suitable for application of the methods of the present invention as described herein may have, for example, an air fill ratio of less than about 1%, less than about 0.7%, and even less than about 0.3%, wherein the air fill ratio is the percent of air (that is, the percent of air provided by the air lines) in the fiber at a pre-selected cross-section. Thus, a 125-micron diameter optical fiber would have less than 1.25 microns of air at a pre-selected cross-section. An optical fiber suitable for use in the present invention may have, for example, an average air line size of about 0.3 microns. In contrast, holey fiber available from NTT, Japan, has an average air line size of about 6 microns. It is the small air line size of the nanostructure fibers that allow the fiber to retain its circularity when the air lines are collapsed as described below.

Further, because of the small size of air lines 40, fibers processed using the air line collapsing methods of the present invention are ITU-T G.652 complaint in that a 125-micron fiber is ±1 micron in diameter for proper connectorization processing after subjecting the fiber to the air line collapsing method because of the less than 1% air fill ratio. In contrast, holey fiber such as photonic crystal fibers having larger holes undergo a diameter change far greater than ±1 micron after collapsing the air holes and thus is not ITU-T G.652 compliant for connectorization. Thus, the methods of the present invention are able to collapse the air lines while retaining about their same cross-sectional diameter and circularity, making the fibers and methods advantageous for mounting within a ferrule and otherwise connectorizing the fiber.

For a variety of optical fiber system applications requiring bend-sensitive fiber, it is desirable for the air lines 40 to be formed to particular air line requirements. The methods of the present invention apply equally well to such fibers. For example, it may be desirable to form air lines 40 such that greater than about 95% of and preferably all of the air lines exhibit a mean air line size in the cladding for the optical fiber which is less than 1550 nm, more preferably less than 775 nm, most preferably less than 390 nm. Likewise, it is preferable that the maximum diameter of the air lines in the fiber be less than 7000 nm, more preferably less than 4000 nm, and even more preferably less than 1550 nm, and most preferably less than 775 nm. In some embodiments, the nanostructure fiber has fewer than 5000 air lines, in some embodiments also fewer than 1000 air lines, and in other embodiments the total number of air lines is fewer than 500 holes in a given optical fiber perpendicular cross-section. Of course, the most preferred fibers will exhibit combinations of these characteristics. Thus, for example, one particularly preferred embodiment of optical fiber would exhibit fewer than 40 air lines in the optical fiber, the air lines having a maximum diameter less than 1550 nm and a mean diameter less than 775 nm, although useful and bend resistant optical fibers can be achieved using larger and greater numbers of air lines. The air line number, mean diameter, max diameter, and total void area percent of air lines can all be calculated with the help of a scanning electron microscope at a magnification of about 800× and image analysis software, such as ImagePro, which is available from Media Cybernetics, Inc. of Silver Spring, Md., USA.

A nanostructure optical fiber 10 may or may not include germania or fluorine to also adjust the refractive index of the core and or cladding of the optical fiber, but these dopants can also be avoided in the intermediate annular region and instead, the air lines (in combination with any gas or gases that may be disposed within the air lines) can be used to adjust the manner in which light is guided down the core of the fiber. The air-line-containing region may consist of undoped (pure) silica, thereby completely avoiding the use of any dopants in the air-line-containing region, to achieve a decreased refractive index, or the air-line-containing region may comprise doped silica, e.g., fluorine-doped silica having a plurality of holes.

In one set of embodiments, nanostructure fiber 10 may have a core 20 that includes doped silica to provide a positive refractive index relative to pure silica, e.g. germania doped silica. The core region is preferably air-line-free. Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

Additional description of nanostructure fibers considered in the present invention is provided in pending U.S. patent application Ser. No. 11/583,098 filed Oct. 18, 2006; and, Provisional U.S. patent application Ser. Nos. 60/817,863 filed Jun. 30, 2006; 60/817,721 filed Jun. 30, 2006; 60/841,458 filed Aug. 31, 2006; 60/841,490 filed Aug. 31, 2006; and 60/879,164, all of which are assigned to Corning Incorporated and incorporated herein by reference.

Note that the nanostructure fibers considered herein can be either single mode or multi-mode and that the methods of the present invention generally apply to both types of nanostructure fibers.

### Optical System

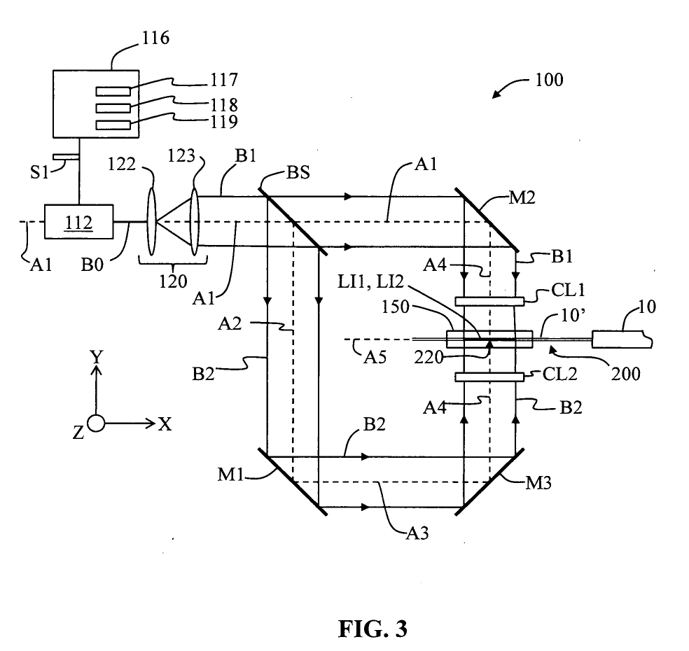

FIG. 3 is a schematic diagram of an example embodiment of an optical system 100 configured for collapsing the air lines 40 in nanostructured region 34 of a nanostructure optical fiber 10 at a particular fiber location, such as a mid-span location or an end location. FIG. 3 and other Figures discussed below include X-Y-Z Cartesian coordinates for the sake of reference. It should be noted here that, while the X-Y plane can be considered the “horizontal” plane for the sake of reference and convenience, in an example embodiment of the present invention, the optical fiber 10 being irradiated is arranged “vertically,” i.e., in the direction of gravity.

Optical system 100 includes at least one laser source 112 arranged along a first optical axis A1. A preferred laser source 112 is a CO₂ laser capable of delivering relatively large amounts of laser power (e.g., 10 W to 20 W) at a mid-infrared (MIR) wavelength λ of between 9.2 μm and 11.4 μm, such as 10.6 μm. An example of a suitable laser source 112 is a 10 W Series 48 CO₂ laser from Synrad, Inc., Mukilteo, Wash.

Laser source 112 is operably coupled to a controller 116, which is configured to control laser source 112, and in particular is adapted to control the amount of optical power outputted by the laser source and the irradiation time of the laser source, as discussed below. In an example embodiment, controller 116 is or includes a computer with a processor 117 and includes an operating system such as Microsoft WINDOWS or LINUX. In an example embodiment, processor 117 is capable of executing a series of software instructions embodied in a computer readable medium and includes, without limitation, a general- or special-purpose microprocessor, finite state machine, microcontroller, computer, central-processing unit (CPU), field-programmable gate array (FPGA), or the like. In an example embodiment, the processor is an Intel XEON or PENTIUM processor, or an AMD TURION or other in the line of such processors made by AMD Corp., Intel Corp. or other semiconductor processor manufacturer. Controller 116 also preferably includes a memory unit (“memory”) 118. As used herein, the term “memory” refers to any processor-readable medium, including but not limited to RAM, ROM, EPROM, PROM, EEPROM, disk, floppy disk, hard disk, CD-ROM, DVD, or the like, that serves as a computer-readable medium on which may be stored a series of instructions executable by a processor. In an example embodiment, controller 116 includes a disk drive 119 adapted to accommodate a removable processor-readable medium (not shown), such as CD-ROM, DVD, memory stick or like storage medium.

Optical system 100 further optionally includes at least one beam-expander/collimator (B/C) optical system 120 arranged along axis Al and downstream of laser 112. B/C optical system is shown as including two optical elements 122 and 123. Fewer or greater optical elements can be included in B/C optical system 120 as needed to achieve the beam-expansion and collimating function. In an example embodiment, B/C optical system 120 includes one or more other optical components (not shown), such as a spatial filter, an attenuator, etc. In an example embodiment, B/C optical system 120 is adjustable so that the width and degree of collimation of the beam exiting the system can be adjusted.

A beamsplitter BS is arranged along axis A1 downstream of B/C optical system 120. Beamsplitter, BS defines a second optical axis A2 perpendicular to first optical axis A1 in the -Y direction, while the first optical axis A1 continues straight through the beamsplitter. Beamsplitter is preferably a 50:50 beam splitter. At least three mirrors M1, M2 and M3 are arranged at three corners of an imaginary rectangle formed by optical axes A1, A2, A3 and A4, with beamsplitter BS residing at the upper left-hand corner of the rectangle. Mirror M1 is arranged along optical axis A2 and is positioned at the lower left-hand corner of the rectangle to form the third optical axis A3 that is parallel to optical axis A1. Mirror M2 is arranged along optical axis A1 downstream of beamsplitter BS and is positioned at the upper right-hand corner of the rectangle to form the fourth optical axis parallel to optical axis A2. Mirror M3 is arranged at the intersection of optical axes A3 and A4 at the lower right-hand corner of the rectangle.

Optical system 100 further includes a pair of cylindrical lenses CL1 and CL2 that are preferably identical with identical focal lengths f. In an example embodiment, cylindrical lenses CL1 and CL2 are both located along optical axis A4 in between mirrors M3 and M4, and are arranged in opposition and equidistant (e.g., at focal length f) from an optical axis A5 that passes between the two lenses and that is parallel to optical axes A1 and A3. The optical power (i.e. curvature) of cylindrical lenses CL1 and CL2 is along the Z-direction (i.e., the lenses have no power (curvature) in the X-direction) so that their respective foci are line foci that lie along axis A5 and that form respective line images LI1 and LI2 at axis A5 in the absence of bare optical fiber 10′. Line images LI1 and LI2 have a width in the Y-direction and a length in the X-direction. In the presence of bare optical fiber 10′, the light that otherwise would form line images LI1 and LI2 converges on a portion 220 of bare optical fiber 10′, as described in greater detail below. However, line images LI1 and LI2 are still useful to discuss in connection with the image-forming properties of cylindrical lenses CL1 and CL2.

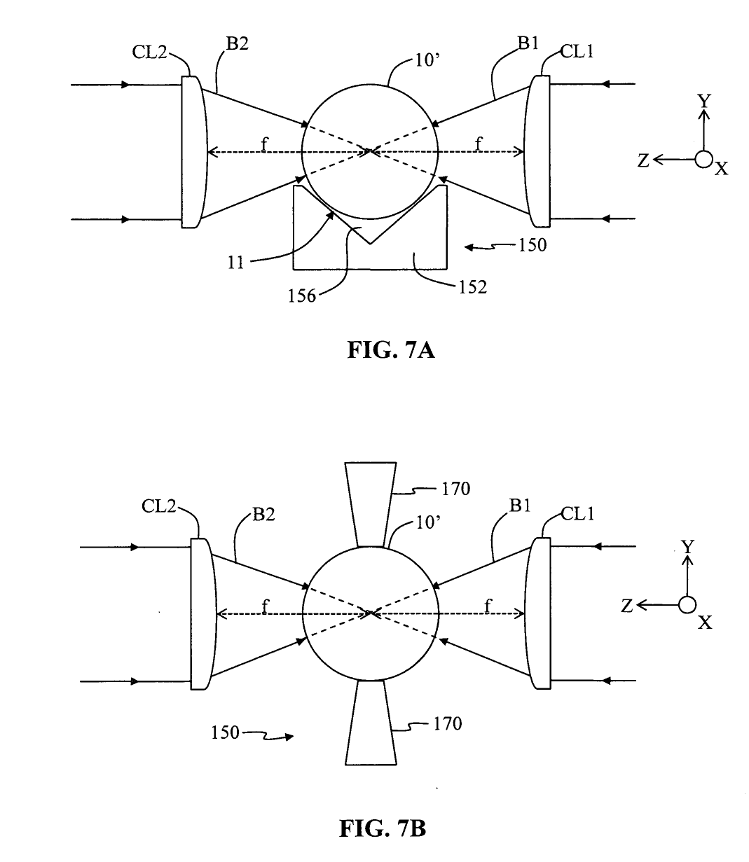

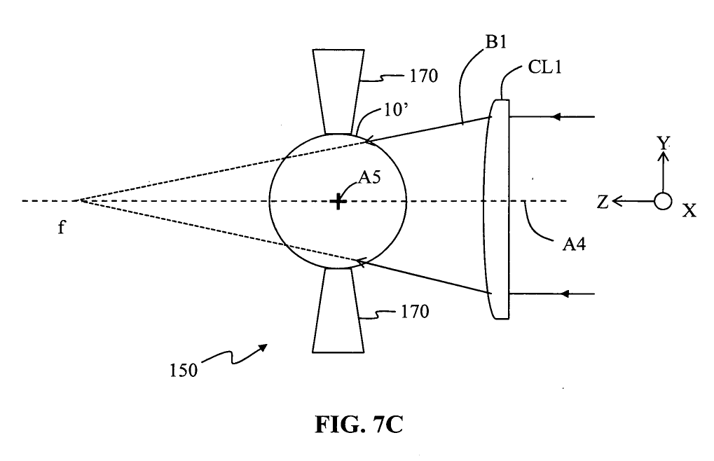

In an example embodiment, cylindrical lenses CL1 and CL2 are made from zinc selenide (ZnSe). In another example embodiment, cylindrical lenses CL1 and CL2 have a focal length f of about 2.5″ and a clear aperture (i.e., diameter) of about 1″, which gives a numerical aperture (NA) of about 0.2. For a wavelength λ=10.6 μm and an NA=0.2, line images LI1 and LI2 have a width (using the Airy disc approximation) of about (2.4)λ/NA˜127 microns, which is about the same at the diameter of a 125 μm optical fiber. Thus, in an example embodiment, the line images have an in-focus width about equal to the diameter of bare optical fiber 10′. Also in an example embodiment, the length of line images LI1 and LI2 are preferably in the range from about 2 mm to about 8 mm, and more preferably between 6 mm and 7 mm. In an example embodiment, cylindrical lenses CL1 and CL2 are arranged at a distance different from focal length f to introduce defocus, which increases the width of line image LI1 and LI2, e.g., to about 200 μm. A defocused example embodiment is discussed in greater detail below in connection with FIG. 7C.

Since beams B1 and B2 are not focused along the long axis (and thus along axis A5), there is not a one-to-one relationship between the length of line images LI1 and LI2 and the length of collapsed air lines 40 in irradiated portion 220. Thus, in an example embodiment with line images LI1 and LI2 of between about 6 mm and 7 mm, about a 3 mm length of an air-line-collapsed portion of bare fiber 10′ is formed in about 2 seconds. The length of the air-line-collapsed portion (discussed below) can be adjusted by increasing or decreasing the width of beams B1 and B2 (e.g., by adjusting B/C optical system 120) or by translating bare fiber 10′ as the fiber is being irradiated, or in a step-wise fashion using a series of separate irradiations. In an example embodiment, the length of air-line-collapsed portion of bare fiber 10′ is preferably between about 0.5 mm and about 5 mm, and more preferably between 1 mm and 3 mm.

In some instances where bare fiber 10′ is to be connectorized, the length of the air-line-collapsed portion required is determined by the amount of precision one can position a fiber optic connector relative to the air-line-collapsed region. For example, if one can epoxy bare fiber 10′ into the fiber optic connector in a very precise manner, then the length of air-line collapsed portion can be minimal (i.e., about 0.5 mm). However, positioning a fiber in an optical fiber connection typically involves some variability, especially in manual assembly processes, due to the relative movement between the fiber optic connector and the fiber during the curing step. Accordingly, in many cases, air-line-collapsed portion length will preferably be longer, e.g., in the aforementioned range of about 1 mm to about 3 mm.

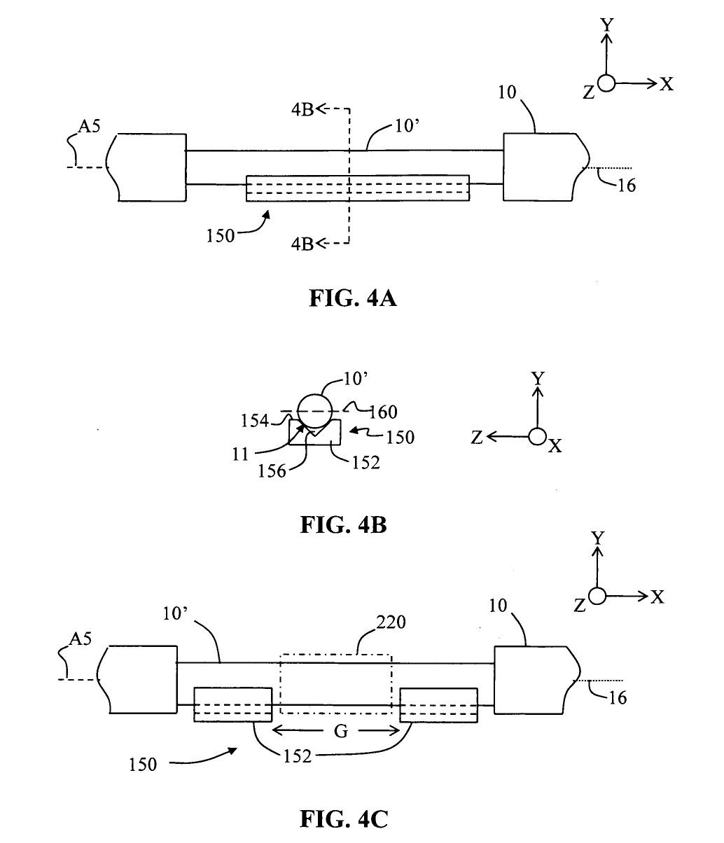

With continuing reference to FIG. 3, optical system 100 further includes a fiber holder 150 arranged along optical axis A5 and configured to hold or otherwise support a section of bare nanostructure fiber 10′ along axis A5. FIG. 4A is a close-up side view and FIG. 4B is an end-on view of an example embodiment of fiber holder 150. Fiber holder 150 of FIG. 4A and FIG. 4B includes a body portion 152 with a top surface 154 that has formed therein a longitudinal V-groove 156. In an example embodiment, V-groove 156 is sized to accommodate a lower portion 11 of bare fiber 10′ so that fiber equator 160 is supported above holder top surface 154.

In an example embodiment, V-groove 156 utilizes either a vacuum or clamps (or both) to hold bare fiber 10′ straight and motionless therein. In an example embodiment, fiber holder 150 is incorporated into a fiber handler (not shown) in a production setting wherein an operator places a section of bare fiber 10′ into the handler and then places the handler into a port that is configured to provide the proper placement of the fiber holder in optical system 100. This allows the bare fiber portion 220 to be irradiated equally from both sides by the line images (foci) LI1 and LI2 formed by cylindrical lenses CL1 and CL2. The process of inserting the bare fiber into the fiber holder and then incorporating the fiber holder into a fiber handler and inserting the fiber handler into optical system 100 facilitates fiber processing.

FIG. 4C is a schematic diagram of an example embodiment of fiber holder 150 similar to that shown in FIG. 4A and FIG. 4B, but wherein body portion 152 includes two separated portions so bare fiber portion 220 spans a gap G between the two body portions. This geometry allows for irradiating bare fiber 10′ without the risk of the focused beams B1 and B2 (discussed below) being obstructed by the body portion 152 of fiber holder 150. This embodiment, however, has the drawback that bare fiber 10′ is not supported when it is heated so that it may sag if the softening temperature is not precisely controlled.

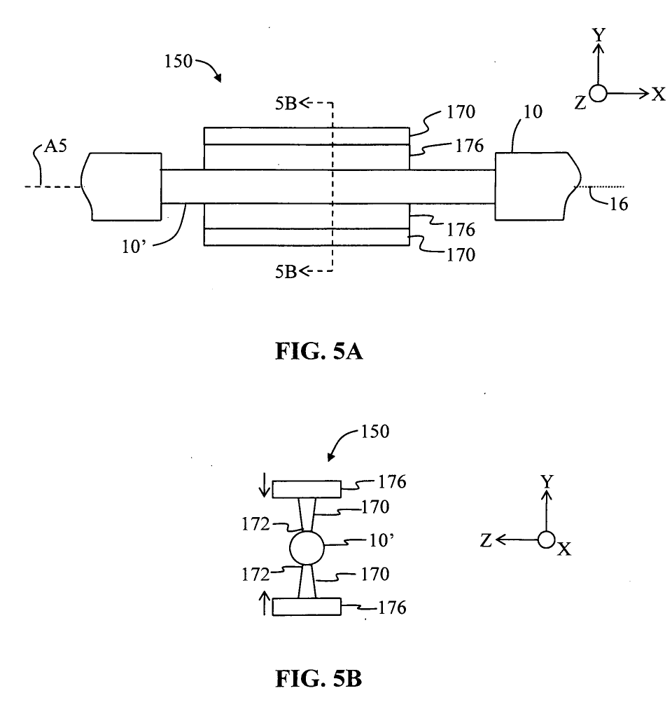

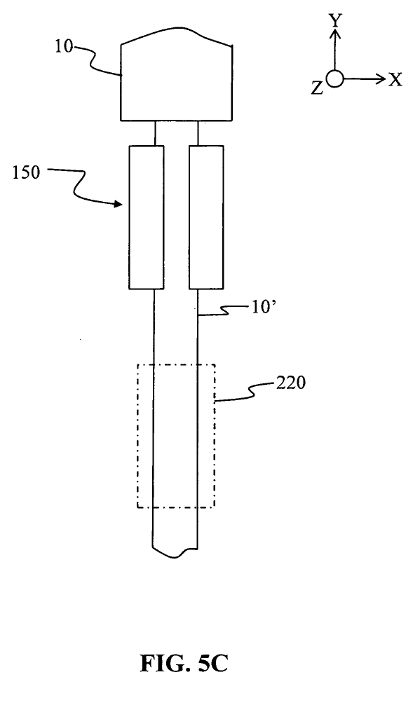

FIG. 5A is a close-up side view and FIG. 5B is an end-on view of another example embodiment of fiber holder 150 and the bare fiber 10′ held therein. Fiber holder 150 includes two opposing prongs 170 each having ends 172 that engage bare fiber 10′ at opposite sides and hold the optical fiber along optical axis A5. In an example embodiment, prong ends 172 are curved or have a V-groove to facilitate holding bare fiber 10′ in place. Each prong 170 is supported by a movable base 176 used to close the gap between ends 172 to gently hold and to release bare fiber 10′.

FIG. 5C illustrates an example embodiment of a fiber holder 150 that holds bare fiber 10′ vertically, so that the fiber is aligned with the force of gravity. This configuration prevents the effects of gravity from distorting (e.g., forming microbends) in bare fiber 10′ when the fiber is softened from the laser heating

In an example embodiment, fiber holder 150 is configured to translate along the axis of bare fiber 10′ so that the bare fiber held therein moves relative to beams B1 and B2. This allows for scanning beams B1 and B2 over bare fiber 10′ rather than performing a static irradiation of one section of the fiber. This also allows for the sequential (e.g., step-wise) exposure of different regions of bare fiber 10′.

### Method of Collapsing the Nanostructure Region

Optical system 100 is used to carry out the method of the present invention of collapsing the air lines in the nanostructure region of nanostructure optical fiber 10 over a portion of the fiber.

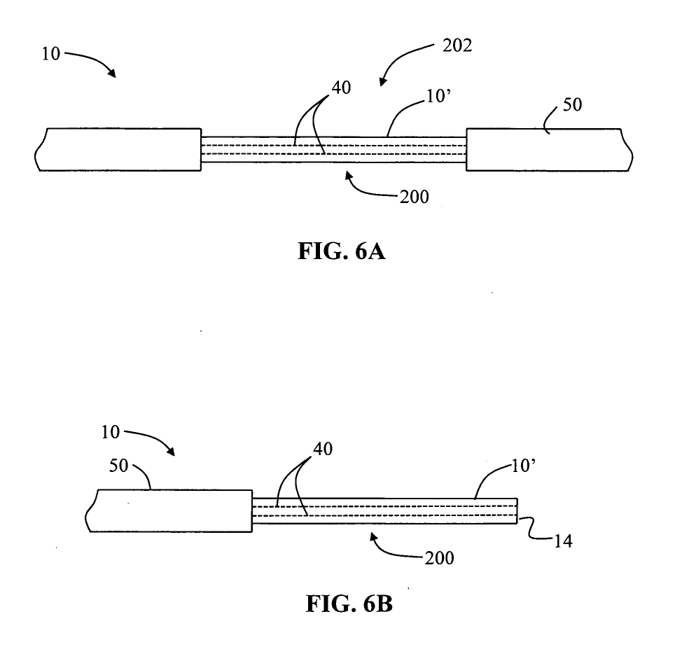

In carrying out the method of the present invention, with reference to FIG. 6A, a section 200 of bare fiber 10′ is exposed at a location 202 by stripping from fiber 10 a portion of outer cover 50 (FIG. 2). In an example embodiment, location 202 is a mid-span location, while in another example embodiment is an end location. Section 200 of bare fiber 10′ is then placed in fiber holder 150 so that the bare fiber is supported with the bare fiber's central axis 16 being coaxial with optical axis A5 and in between cylindrical lenses CL1 and CL2, as shown in FIG. 3. FIG. 6B illustrates an example embodiment where fiber 10 is cut so that section 200 includes a bare fiber end 14. In this regard, what starts out as a mid-span location 202 becomes an end location 202.

Once bare fiber 10′ is properly positioned in optical system 100 via fiber holder 150, then with reference again to FIG. 3, controller 116 sends a control signal S1 to laser source 112, which causes the laser source to emit a laser beam B0 along optical axis A1. In an example embodiment, laser source 112 is a pulsed source and beam B0 consists of a train of optical pulses. Laser beam B0 is received by B/C optical system 120, which expands and collimates beam B0 to form a first beam B1 that travels along optical axis A1. In an example embodiment, B/C optical system 120 is anamorphic and configured to form a rectangular cross-section beam B1 from a circular cross-section beam B0.

Beam B1 encounters beamsplitter BS, which passes a portion (e.g., half) of beam B1 and reflects a portion (e.g., half) of beam B1 to form a second beam B2. Beam B2 travels along optical axis A2 toward mirror M1 and preferably has the same or substantially the same amount of optical power as beam B1. The portion of beam B1 that passes through beamsplitter BS continues traveling along optical axis A1 and reflects from mirror M2. This directs beam B1 down optical axis A4 in the −Y direction to cylindrical lens CL1. Meanwhile, beam B2 traveling along optical axis A2 is incident upon and is reflected by mirror M1 to travel along optical axis A3, where it is reflected by mirror M3 to travel along optical axis A4 in the +Y direction to cylindrical lens CL2.

With reference now also to FIG. 7A and FIG. 7B, in an example embodiment, cylindrical lenses CL1 and CL2 attempt to bring respective beams B1 and B2 to respective line foci L1 and LI2 at optical axis A5. This serves to irradiate a portion 220 of bare fiber 10′ with converging laser beams substantially the same amount of optical energy from opposite sides, thereby creating an even heat distribution throughout the bare fiber. The power level provided by laser source 112 is controlled by controller 116 via control signals SI, and the positions of cylindrical lenses CL1 and CL2 each being essentially the same distance away from optical axis A5 results in a precise amount of energy being delivered to bare fiber portion 220.

Because beams B1 and B2 have a MIR wavelength λ, the light is absorbed very quickly by bare fiber 10′, which is typically made of silica. Thus, for a MIR wavelength k=10.6 μm, the light is absorbed in a depth of about one wavelength, or about a 10 μm shell-like region of the outer portion of the bare fiber. This is a relatively small portion of a 125 μm diameter fiber. The absorbed light is converted to heat, which then diffuses toward the center of the optical fiber until the heat (temperature) distribution is substantially uniform throughout the irradiated portion of bare fiber 10′.

In the present invention, the amount of energy provided to fiber portion 220 raises the temperature of the bare fiber to the “softening” point and no higher. The typical “softening point” temperature T_{S} for a bare nanostructure fiber 10′ is in the range from about 1585° C. to about 1685° C. A typical amount of optical power that achieves a softening-point temperature within the aforementioned rage is from about 2.5 W to about 6 W for an irradiation time t₁ ranging from between about 2 seconds to about 5 seconds. Heating the bare fiber 10′ beyond the softening point (i.e., maximum softening temperature T_{S}) causes the bare fiber to change size, e.g., by necking down or by bulging, which is undesirable, particularly when seeking to connectorize the processed fiber.

Once the irradiated portion 220 of bare fiber 10′ reaches the “softening” state, the random air lines 40 in the portion collapse, leaving a solid section of cladding 30 surrounding core 20 over bare fiber portion 220. At this point, bare fiber portion 220 is now referred as the air-line-collapsed portion 220. In an example embodiment, beams B1 and B2 and lenses CL1 and CL2 are configured so that portion 220 has an axial length of between about 2 mm and about 8 mm, which axial length corresponds in size to an example line length for line foci LI1 and LI2 from the cylindrical lenses (FIG. 3).

FIG. 7C is similar to FIG. 7B and illustrates an example embodiment where cylindrical lenses CL1 and CL2 have a focal length f greater than their distance from axis A5. Only cylindrical lens CL1 is shown in FIG. 7C for the sake of clarity. This arrangement allows for irradiating a relatively large area on both sides of bare fiber 10′, which helps keeps the energy density level in beams B1 and B2 below that which would ablate the fiber. An example configuration utilizes a focal length f=3″ with the axial distance from each lens to axis A5 being about 2.5″. Note that because of the absorption of beams B1 and B2 by bare fiber 10′, the beams do not actually come to a focus at their focal length f on the other side of the fiber, hence the use of dashed lines to shown beam B1 focusing through the fiber to focus f. In this way, beams B1 and B2 are made to converge onto bare fiber 10′ without actually coming to a focus within the fiber.

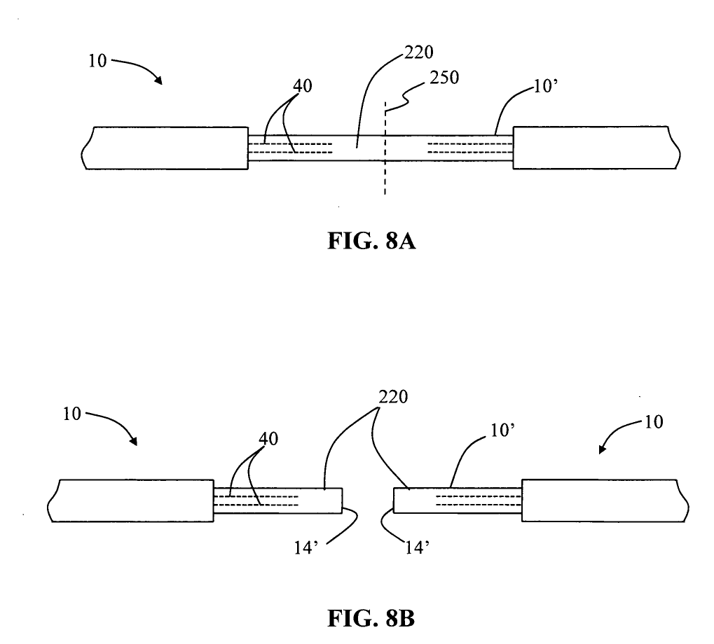

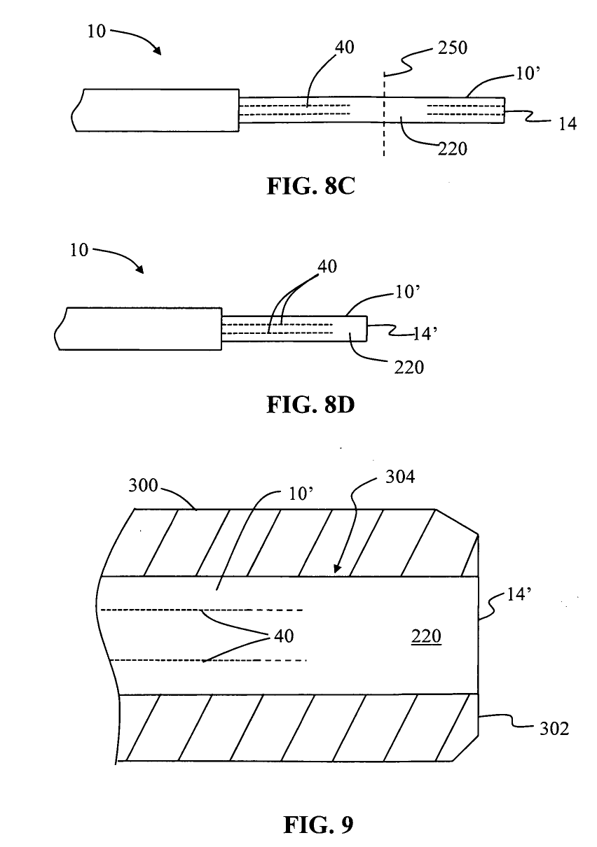

Once air-line-collapsed portion 220 is formed, then the fiber is removed from fiber holder 150. With reference to FIG. 8A and FIG. 8B, bare fiber 10′ is then cleaved at a plane 250 within air line-collapsed portion 220, thereby forming two fiber sections each having a solid end 14′.

With reference to FIG. 8C and FIG. 8D, when fiber 10 is prepared according to FIG. 6B at an end location 202, a single solid fiber end 14′ is formed when the bare fiber is cleaved at plane 250.

When the random air lines are collapsed using the methods of the present invention, there is no appreciable change in the size of bare fiber 10′ within air-line-collapsed portion 220 relative to the other portions of the bare fiber. In addition, solid end 14′ associated with air-line-collapsed portion 220 reacts to conventional scribing and polishing techniques just like non-nanostructure optical fibers, such as Corning SMF 28.

FIG. 9 is a schematic cross-sectional diagram of an example embodiment of a connector ferrule 300 having an end face 302 and a ferrule channel 304. An end section of bare nanostructure fiber 10′ having a collapsed air line portion 220 as formed as described above and as illustrated in FIG. 8A through FIG. 8C is contained within ferrule channel 304, with collapsed air line portion 200 and its corresponding end 14′ arranged at end face 302. This structure can be used to form a connectorized nanostructure fiber end, wherein the end face 14′ is solid and thus no longer prone to the aforementioned adverse effects associated with air line contamination.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method of forming a collapsed air line region in a nanostructure optical fiber having a region with air lines adjacent a cladding region, comprising:
initiating irradiation of a portion of the nanostructure optical fiber from essentially opposite directions with at least first and second laser beams having substantially equal power and essentially the same mid-infrared wavelength; and
continuing said irradiation for an irradiation time t₁ so as to bring the optical fiber portion to a softening temperature T_{S} in the range from about 1585° C. to about 1685° C. at which the air lines in the optical fiber portion collapse into the adjacent cladding.

2. The method of claim 1, further including supporting the optical fiber portion during said irradiating with a fiber holder configured to allow the optical fiber portion to be irradiated from opposite directions.

3. The method of claim 1, further including cleaving the optical fiber at a position within the optical fiber portion so as to form at least one solid optical fiber end.

4. The method of claim 3, including arranging said optical fiber end at an end face of a connector ferrule.

5. A method of collapsing air lines in a portion of a nanostructure optical fiber that includes an air line region formed within a cladding region, comprising:
forming first and second laser beams each having a mid-infrared (MIR) wavelength and an optical power that are the same or substantially the same;
irradiating the optical fiber portion with the first and second laser beams from opposite directions so as to uniformly heat the optical fiber portion;
carrying out said irradiating for an irradiation time t₁ to bring the optical fiber portion to a softening temperature at which the air lines collapse into the cladding region.

6. The method of claim 5, further including focusing the first and second laser beams so that the first and second laser beams converge onto the optical fiber.

7. The method of claim 5, including moving the optical fiber relative to the first and second laser beams during said irradiating.

8. The method of claim 5, wherein the irradiated optical fiber portion has a length in the range between about 2 mm and about 8 mm.

9. The method of claim 5, wherein the MIR wavelength is 10.6 μm.

10. The method of claim 5, including forming the first and second laser beams from a single laser beam.

11. The method of claim 5, including supporting the optical fiber portion in an optical fiber holder configured to hold the optical fiber either parallel to gravity or perpendicular to gravity, and to allow for said irradiation of the optical fiber portion from opposite directions.

12. The method of claim 5, further including after terminating said irradiating:
cleaving said optical fiber at said optical fiber portion so as to form at least one optical fiber end that has no air lines.

13. The method of claim 12, including containing at least a portion of the cleaved optical fiber portion in a connector ferrule having an end face, including arranging the optical fiber end having no air lines at the ferrule end face.

14. The method of claim 5, wherein the softening temperature T_{S} is in the range from about 1585° C. to about 1685° C.

15. The method of claim 5, wherein the first and second laser beams each have an optical power in the range from about 2.5 W to about 6 W.

16. The method of claim 15, wherein the irradiation time t₁ is in the range from about 2 seconds to about 5 seconds.

17. An optical system for collapsing air lines in a portion of a nanostructure optical fiber that includes airlines within an air line region formed within a cladding region, comprising:
at least one laser source adapted to emit an initial laser beam having a mid-infrared (MIR) wavelength;
at least one beamsplitter arranged downstream of a beam-expansion/collimation (B/C) optical system and adapted to form from the initial laser beam at least first and second laser beams having substantially the same optical power;
a mirror system comprising at least first, second and third mirrors configured to direct the first and second laser beams to travel along a common optical axis but in essentially opposite directions; and
at least first and second cylindrical lenses arranged on respective sides of a fiber holder and configured along said common optical axis so as to respectively receive the first and second laser beams and form therefrom at least first and second convergent laser beams that irradiate sides of the optical fiber portion to effectuate uniform heating of the optical fiber portion so as to collapse the air lines into the cladding region.

18. The optical system of claim 17, further including a controller adapted to control the operation of the laser source so as to deliver a select amount of heat to the optical fiber portion via the first and second laser beams in order to heat the optical fiber to a softening temperature T_{S}.

19. The optical system of claim 18, wherein the softening temperature T_{S} is in the range from about 1585° C. to about 1685° C.

20. The optical system of claim 17, wherein the fiber holder is configured to support the optical fiber portion either parallel or perpendicular to gravity and to allow for the optical fiber portion to be irradiated from opposite directions by the first and second converging laser beams.
